(19) United States
(12) Patent Application Publication
(10) Pub. No.: US 2022/0405534 A1
(43) Pub. Date: Dec. 22, 2022

(54) LEARNING APPARATUS, INFORMATION INTEGRATION SYSTEM, LEARNING METHOD, AND RECORDING MEDIUM

(71) Applicant: NEC Corporation, Minato-ku, Tokyo (JP)

(72) Inventors: Eiji KANEKO, Tokyo (JP); Azusa SAWADA, Tokyo (JP); Kazutoshi SAGI, Tokyo (JP)

(73) Assignee: NEC Corporation, Minato-ku, Tokyo (JP)

(21) Appl. No.: 17/772,793

(22) PCT Filed: Mar. 3, 2020
(86) PCT No.: PCT/JP2020/008844

§ 371 Date: Apr. 28, 2022

(30) Foreign Application Priority Data
Nov. 8, 2019 (JP) PCT/JP2019/043909

(51) Int. Cl. G06K 9/62; G06N 20/00

(52) U.S. Cl. CPC G06K 9/6277; G06K 9/628; G06N 20/00

(57) ABSTRACT

A prediction unit classifies input data into a plurality of classes using a predictive model, and outputs a predicted probability for each class as a prediction result. A grouping unit generates a grouped class formed by k classes within top k predicted probabilities, and calculates a predicted probability of the grouped class. A loss calculation unit calculates a loss based on predicted probabilities of a plurality of classes including the grouped class. A model update unit updates the predictive model based on the calculated loss.

### TECHNICAL FIELD

The present some non-limiting embodiments relate to a technique for identifying an object based on an image.

### BACKGROUND ART

Recently, an object discrimination technique by a neural network using deep learning has been proposed. An object discriminator detects a target object from an image using an object discriminative model, and outputs a probability indicating which of a plurality of classes the target object corresponds to. Usually, at the time of learning, an index representing a difference is calculated for each class using a plurality of classes predicted by the object discriminator and a plurality of classes indicating respective correct answers prepared in advance, and parameters of the object discriminator are updated based on a sum of indexes.

On the other hand, a method has been proposed in which a process is performed by focusing on multiple classes with high predicted probabilities output by the object discriminative model. For instance, Patent Document 1 describes a learning method that calculates a correct answer rate using data for which scores predicted by a determination model belong to a predetermined number from a top score, and determines whether or not the determination model needs to be updated based on the correct answer rate.

### PRECEDING TECHNICAL REFERENCES

### Patent Document

Patent Document 1: International Publication Pamphlet No. WO2014/155690

### SUMMARY

### Problem to be Solved

A general object discriminator is learned to predict one class with high accuracy from an input image, but depending on a photographing environment or the like of the input image, the accuracy may be reduced in a case where a prediction result is focused down to one class. In such a case, it may be preferable to obtain a prediction result including a correct answer with high probability in multiple classes rather than the accuracy is reduced.

It is one object of the present disclosure to generate a model that outputs a prediction result indicating that a subject object is included with high probability in a plurality of classes.

### Means for Solving the Problem

According to an example aspect of the present disclosure, there is provided a learning apparatus including:

a prediction unit configured to classify input data into a plurality of classes by using a predictive model, and output a predicted probability for each class;

a grouping unit configured to generate a grouped class formed by k classes within top k predicted probabilities based on the predicted probability for each class, and calculate a predicted probability of the grouped class;

a loss calculation unit configured to calculate a loss based on predicted probabilities of the plurality of classes including the grouped class; and

a model update unit configured to update the predictive model based on the calculated loss.

According to another example aspect, there is provided a learning method including:

classifying input data into a plurality of classes using a predictive model and outputting a predictive probability for each class as a prediction result;

generating a grouped class formed by k classes within top k predicted probabilities based on the predicted probability for each class, and calculating a predicted probability of the grouped class;

calculating a loss based on predicted probabilities of the plurality of classes including the grouped class; and

updating the predictive model based on the calculated loss.

According to a further example aspect, there is provided a recording medium storing a program, the program causing a computer to perform a process including:

classifying input data into a plurality of classes using a predictive model and outputting a predictive probability for each class as a prediction result;

generating a grouped class formed by k classes within top k predicted probabilities based on the predicted probability for each class, and calculating a predicted probability of the grouped class;

calculating a loss based on predicted probabilities of the plurality of classes including the grouped class; and

updating the predictive model based on the calculated loss.

### Effect

According to the present disclosure, it is possible to generate a model that outputs a prediction result indicating that a subject object is included with high probability in a plurality of classes.

### BRIEF DESCRIPTION OF THE DRAWINGS

FIG. 1 illustrates a hardware configuration of a learning apparatus according to a first example embodiment.

FIG. 2 is a block diagram illustrating a functional configuration of the learning apparatus according to a first example.

FIG. 3 is a flowchart of a learning process in a first example.

FIG. 4 illustrates an example of a method for grouping a plurality of classes.

FIG. 5 is a block diagram illustrating a functional configuration of a learning apparatus according to a second example.

FIG. 6 is a flowchart of a learning process in the second example.

FIG. 7 is a block diagram illustrating a functional configuration of a learning apparatus according to a third example.

FIG. 8 is a flowchart of a learning process according to the third example.

FIG. 9 is a block diagram illustrating a configuration of an information integration system.

FIG. 10 is a block diagram illustrating a functional configuration of a learning apparatus according to a second example embodiment.

### EXAMPLE EMBODIMENTS

In the following, example embodiments will be described with reference to the accompanying drawings.

### First Example Embodiment

(Hardware Configuration)

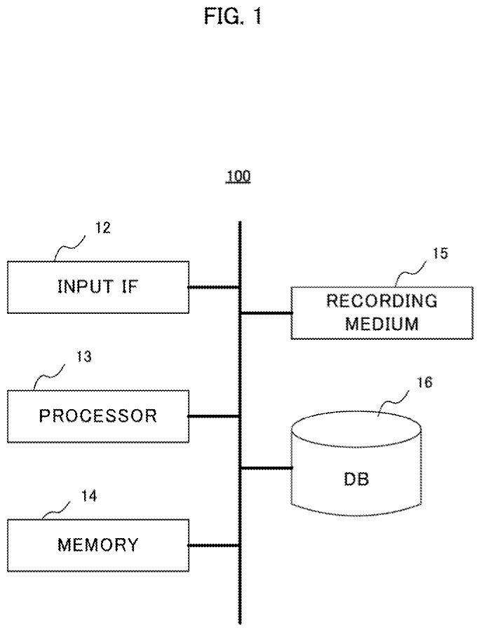

FIG. 1 is a block diagram illustrating a hardware configuration of a learning apparatus according to a first example embodiment. As illustrated, the learning device 100 includes an input IF (InterFace) 12, a processor 13, a memory 14, a recording medium 15, and a database (DB) 16.

The input IF 12 inputs data used for learning of the learning apparatus 100. Specifically, training input data and target data for training to be described later are input through the input IF 12. The processor 13 is a computer such as a CPU (Central Processing Unit) or a GPU (Graphics Processing Unit), and controls the entire learning apparatus 100 by executing programs prepared in advance. Specifically, the processor 13 executes a learning process, which will be described later.

The memory 14 is formed by a ROM (Read Only Memory), a RAM (Random Access Memory), or the like. The memory 14 stores various programs to be executed by the processor 13. The memory 14 is also used as a working memory during executions of various processes by the processor 13.

The recording medium 15 is a non-volatile and non-transitory recording medium such as a disk-shaped recording medium, a semiconductor memory, or the like, and is formed to be detachable from the learning apparatus 100. The recording medium 15 records various programs executed by the processor 13. In a case where the learning apparatus 100 executes various kinds of processes, a program recorded on the recording medium 15 is loaded into the memory 14 and executed by the processor 13.

The database 16 stores data input from an external apparatus including the input IF 12. Specifically, data used to learn the learning apparatus 100 are stored in the database 16. In addition to the above, the learning apparatus 100 may include an input device such as a keyboard, a mouse, or the like for a user to perform instructions or inputs, and a display unit.

### First Example

Next, a first example of the first example embodiment will be described.

(1) Functional Configuration

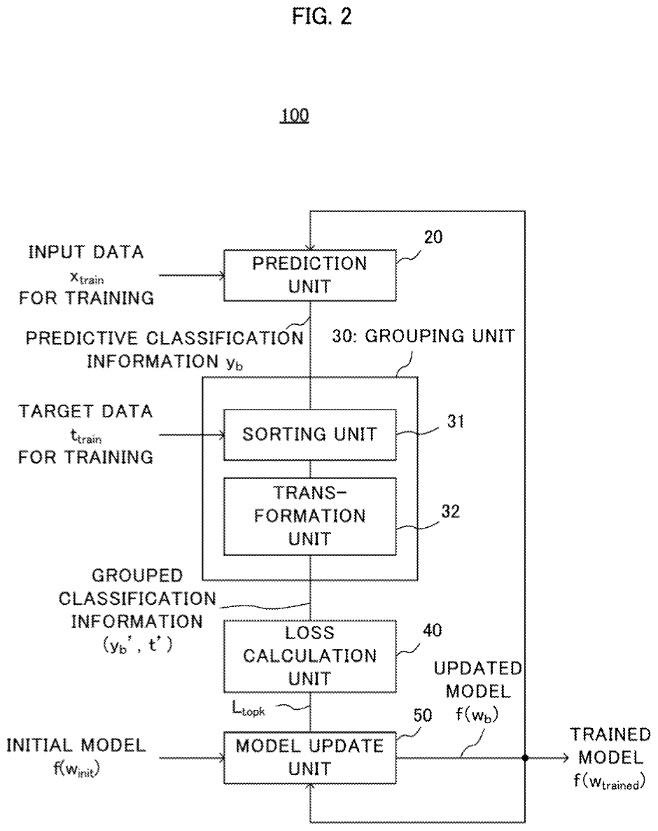

FIG. 2 is a block diagram illustrating a functional configuration of the learning apparatus 100 according to the first example. As illustrated, the learning apparatus 100 includes a prediction unit 20, a grouping unit 30, a loss calculation unit 40, and a model update unit 50. At a time of learning, input data xₜᵣₐᵢₙ for training (hereinafter, simply referred to as “input data xₜᵣₐᵢₙ.”) and target data tₜᵣₐᵢₙ for training (hereinafter, simply referred to as “target data tₜᵣₐᵢₙ.”) are prepared. The input data xₜᵣₐᵢₙ are input to the prediction unit 20, and the target data tₜᵣₐᵢₙ are input to the grouping unit 30. Moreover, an initial model f(wᵢₙᵢₜ) to be learned is input to the model update unit 50. Incidentally, at a beginning of the learning, the initial model f(wᵢₙᵢₜ) is set in the prediction unit 20.

The prediction unit 20 predicts the input-data xₜᵣₐᵢₙ using the initial model f(wᵢₙᵢₜ) which is set inside. The input data xₜᵣₐᵢₙ are image data, and the prediction unit 20 performs a feature extraction from the image data, predicts a subject object included in the image data based on the extracted feature amount, and performs a class classification. The prediction unit 20 outputs predictive classification information y_{b} as a prediction result. The predictive classification information y_{b} outputs a predicted probability that the input data xₜᵣₐᵢₙ corresponds to each of classes. Specifically, the predictive classification information y_{b} is given by the following formula.

[Formula 1]

y_{b}=[y_{b,1}, . . . ,y_{b,N}]^{T} (1)

where “N” denotes the number of classes. A subscript “b” denotes the number of learning operations. Therefore, a first prediction result based on the initial model f(wᵢₙᵢₜ) is predictive classification information y₁.

The grouping unit 30 includes a sorting unit 31 and a transformation unit 32. The target data tₜᵣₐᵢₙ are input to the sorting unit 31. The target data tₜᵣₐᵢₙ are given by the following formula.

[Formula 2]

tₜᵣₐᵢₙ=[t₁, . . . ,t_{N}]^{T} (2)

The sorting unit 31 sorts the predictive classification information y_{b} in order of magnitude, that is, in a descending order of predicted probabilities, and obtains the following predictive classification information y′_{b}.

[Formula 3]

y′_{b}=sort_{y}(y_{b})=[y′_{b,1}, . . . ,y′_{b,k}]^{T} (3)

Moreover, the sorting unit 31 sorts the target data tₜᵣₐᵢₙ in the same order as that of the predictive classification information y_{b}, that is, in order of the size of the predictive classification information y_{b}, and generates the following target data t′.

[Formula 4]

t′=sort_{y}(tₜᵣₐᵢₙ)=[t′₁, . . . ,t′ₖ]^{T} (4)

Next, the transformation unit 32 combines top k classes of predicted probabilities into one class. Specifically, the transformation unit 32 makes one class (hereinafter, referred to as a “topk class.”) by k classes which predicted probabilities are higher. After that, the transformation unit 32 calculates a sum of the predicted probabilities of the top k classes of the predictive classification information y′_{b} as a predicted probability y′ₜₒₚₖ of the topk class by the following formula.

[Formula 5]

y′ₜₒₚₖ:=Σᵢ₌₁^{k}y′_{b,i} (5)

Then, the transformation unit 32 replaces predicted probabilities of top k classes in the predictive classification information y′_{b} indicated by the expression (3) with predicted probabilities y′_{b, topk} of the topk class as follows.

[Formula 6]

y′_{b}=[y′_{b,topk},y′_{b,k+1}, . . . ]^{T} (6)

Similarly, the transformation unit 32 calculates a sum of values of target data t′ for the top k classes of the predictive classification information y′_{b} as a value t′ₜₒₚₖ of target data of the topk class by the following formula.

[Formula 7]

t′ₜₒₚₖ=Σᵢ₌₁^{k}t′ᵢ (7)

After that, the transformation unit 32 replaces the values of the top k classes of the target data t′ shown in formula (4) with the value t′ₜₒₚₖ of the target data for the top k class.

[Formula 8]

t′=[t′ₜₒₚₖ,t′ₖ₊₁, . . . ]^{T} (8)

Accordingly, the transforming unit 32 outputs the predicted classification information (hereinafter, referred to as “grouped predictive classification information”) y′_{b} in which the predicted probability corresponding to the topk class is replaced, and the target data (hereinafter, referred to as “grouped target data”) t′ in which the value corresponding to the topk class is replaced, as grouped classification information (y′_{b}, t′) to the loss calculation unit 40.

The loss calculation unit 40 calculates a loss Lₜₒₚₖ using the grouped classification information (y′_{b}, t′) by the following formula.

[Formula 9]

Lₜₒₚₖ=−Σ_{i∈I}t′ᵢ log y′_{b,i}

I={topk,k+1, . . . ,N} (9)

Alternatively, the loss calculation unit 40 may calculate the loss Lₜₒₚₖ using the grouped classification information (y′_{b}, t′) according to the following formula.

$$[ Formula 10 ]$$

$${L}_{topk} = {\sum }_{i ∈ I} {t}_{i}^{′} log ( \frac{{t}_{i}^{′}}{{y}_{b , i}} ) \qquad ( {9}^{′} )$$

Based on the loss Lₜₒₚₖ, the model update unit 50 generates an updated model f(w_{b}) by updating parameters of a model set in the model update unit 50, and sets the updated model f(w_{b}) in the model update unit 50 and the prediction unit 20. For instance, in a first update, the model update unit 50 and the initial model f(wᵢₙᵢₜ), which is set in the prediction unit 20, are updated to the updated model f(w₁).

The model update unit 50 repeats the above-described process until a predetermined end condition is provided, and terminates the learning when the end condition is provided. For instance, the end condition may be that the parameters of the model are updated a predetermined number of times, that a predetermined amount of target data prepared are used, that the parameter of the model has been converged to a predetermined value, and the like. After that, the updated model f(w_{b}) at a time of terminating the learning is output as a trained model f(w_{trained}).

(2) Learning Process

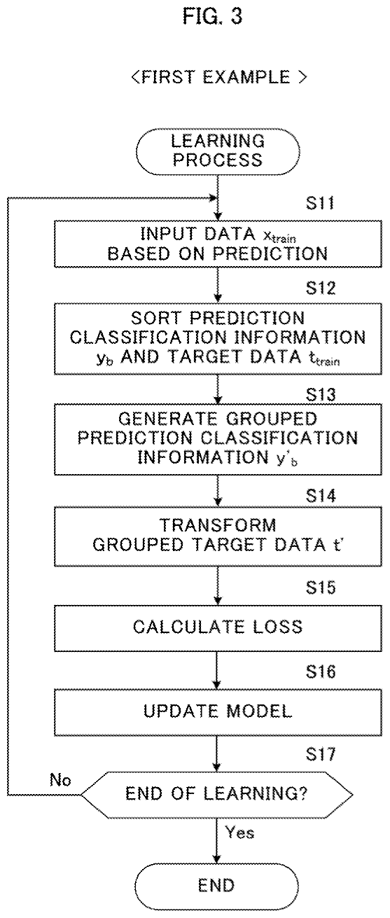

FIG. 3 is a flowchart of a learning process according to the first example. This process is realized by the processor 13, which is depicted in FIG. 1, executes a program prepared in advance, and operates as each of elements depicted in FIG. 2. At a start of the learning process, the initial model f(wᵢₙᵢₜ) is set in the prediction unit 20 and the model update unit 50.

First, the prediction unit 20 predicts a class with respect to input data xₜᵣₐᵢₙ and outputs predictive classification information y_{b} shown in the expression (1) as a prediction result (step S11). Next, as shown in expressions (3) and (4), the sorting unit 31 of the grouping unit 30 sorts the predictive classification information y_{b} and target data tₜᵣₐᵢₙ for training (step S12).

Next, the transformation unit 32 of the grouping unit 30 calculates a predicted probability y′ₜₒₚₖ for the topk class shown in the expression (5) based on top k predicted probabilities from the sorted predictive classification information y′_{b}, and generates the grouped predictive classification information y′_{b} by replacing the predicted probabilities of the k classes forming the topk class with the predicted probability y′_{b, topk} of the topk class as shown in the expression (6) (step S13). Moreover, the transformation unit 32 calculates the value t′ₜₒₚₖ of the target data for the topk class shown in the expression (7), and generates the grouped target data t′ by replacing values of the target data for the k classes forming the topk class in the target data t′ with the value t′ₜₒₚₖ of the target data for the topk class as shown in the expression (8) (step S14).

Next, the loss calculation unit 40 calculates the loss Lₜₒₚₖ based on the expression (9) or the expression (9′) using the grouped predictive classification information y′_{b} and the grouped target data t′ (step S15). Next, the model update unit 50 updates parameters of a model so as to reduce the loss Lₜₒₚₖ, and sets the updated model f(w_{b}) to the prediction unit 20 and the model update unit 50 (step S16).

Next, the model update unit 50 determines whether or not a predetermined end condition is provided (step S17). When the end condition is not provided (step S17: No), processes of steps S11 through S16 are performed using next input data xₜᵣₐᵢₙ and next target data tₜᵣₐᵢₙ. On the other hand, when the end condition is provided (step S17: Yes), this learning process is terminated.

As described above, in the first example, the loss is calculated by considering the k classes having the higher predicted probabilities indicated by the predictive classification information y_{b} as one class called the topk class, and the parameters of the model are updated. Therefore, it is possible for the model obtained by training to detect with high accuracy that there is a correct answer within the top k classes in the predicted probability.

(3) Grouping Methods

In this example, as a method for grouping a plurality of classes, the following methods can be considered. A class created by grouping is referred to as a “grouping class” below.

(A) Grouping Top k Classes

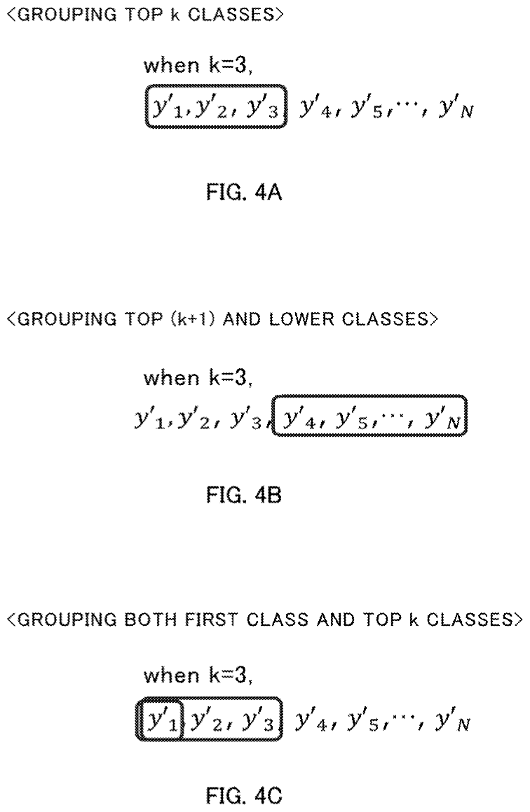

FIG. 4A illustrates method for grouping the top k predicted probabilities. The grouped class, which is obtained in this method, is the topk class described above. As described above, the grouping unit 30 sorts predicted probabilities of classes indicated by the predictive classification information y_{b} in a descending order, and groups top k classes into a single grouped class. For instance, when k=3, a grouped class is formed by three top classes with high predicted probabilities.

(B) Grouping a (k+1)th and Lower Classes

FIG. 4B illustrates a method for grouping classes equal to or lower than the (k+1)th in the descending order of predicted probabilities. In this method, predicted probabilities of classes indicated by the predictive classification information y_{b} are sorted in descending order, and classes other than the top k classes, that is, classes with predicted probabilities equal to or lower than the (k+1)th, are grouped into a single grouped class. For instance, when k=3, a grouped class is formed by classes other than the three classes with higher predicted probabilities. In this case, a predicted probability of the grouped class indicates a probability that the top k predicted probabilities do not include a correct answer.

(C) Grouping Both the Top k Classes and (k+1)th or Lower Classes

The above-described method for grouping top k classes and the above-described method for grouping the (k+1)th or lower classes may be used together.

(D) Grouping Both a First Class and the Top k Classes

FIG. 4C illustrates a method for grouping both a first class and top k classes in the predicted probabilities. In this method, both the first class and the top k classes described above are used among the predicted probabilities of classes indicated by the predicted classification information y_{b}. In an example of k=3, a top3 class is created by grouping classes which predicted probabilities are up to a top three rank, and a class which predicted probability is the first rank (referred to as a “top1 class”) is processed as one class separately from the top3 class. In this case, the model is trained so that a probability that the topk class has a correct answer increases and at the same time, a probability that the top1 class has the correct answer increases.

In the above grouping method, it is assumed that the number “k” of classes to be grouped is predetermined, but instead, the grouping unit 30 may automatically estimate a value of k. In the first method in this case, the grouping unit 30 determines a value of k such that the predicted probabilities of the top k classes are all equal to or greater than a specific value. In this method, grouping classes are formed by a plurality of classes with predicted probabilities equal to or greater than the specific value. That is, the value of “k” is the number of classes having a predicted probability equal to or greater than a specific value. In the second method, the grouping unit 30 determines the value of k so that a cumulative predicted probability of the top k classes is equal to or greater than a specific value. In this method, for instance, in a case where the cumulative predicted probability of the classes from the first rank to the fourth rank is equal to or greater than the specific value, a grouped class is formed by top four classes.

(4) Predicted Probability of the Grouped Class

In the above example embodiment, as shown in the expression (5), a sum of the predicted probabilities of the plurality of classes belonging to the grouped class is set as the predicted probability of the grouped class. This method is used in a case where one set of input data has any one of classes. On the other hand, in a case of a problem in which one set of input data can have multiple classification results at the same time (so-called multi-class problem), the predicted probability of the grouped class is a probability of an exclusive event of “an event that is not any of the k classes”, and is given by the following formula.

[Formula 11]

y′_{b,topk}:=1−Πᵢ₌₁^{k}(1−y′_{b,i}) (10)

### Second Example

Next, a second example of the present disclosure will be described. In the first example, the predictive classification information y′_{b} and the target data t′ are transformed for the topk class to determine the loss. Instead, in the second example, only the target data t′ are transformed for the topk class to determine the loss.

(1) Functional Configuration

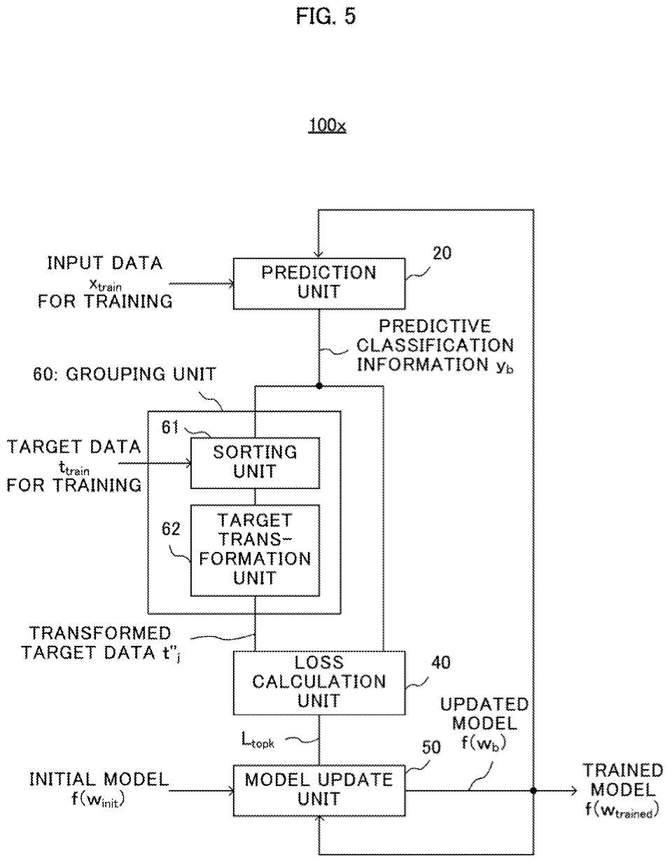

FIG. 5 is a block diagram illustrating a functional configuration of a learning apparatus 100x according to the second example. As illustrated, the learning apparatus 100x includes a grouping apparatus 60, instead of the grouping unit 30 in the learning apparatus 100 according to the first example. The grouping unit 60 includes a sorting unit 61, a target transformation unit 62. The predictive classification information y_{b} output from the prediction unit 20 is input to the grouping unit 60 and the loss calculation unit 40. Except for this point, since the configuration of the learning apparatus 100x is the same as that of the learning apparatus 100 of the first example embodiment, the explanations of common parts will be omitted.

The prediction unit 20 predicts a class for the input data xₜᵣₐᵢₙ, and outputs predictive classification information y_{b} to the grouping unit 60 and the loss calculation unit 40. The sorting unit 61 of the grouping unit 60 sorts classes in the descending order of predicted probabilities indicated by the predictive classification information y_{b}, calculates predictive classification information y′_{b} and target data t′ according to the above-described expressions (3) and (4) after sorting, and selects higher k classes to group into as a topk class.

The target transformation unit 62 uses the predictive classification information y′_{b} to transform the target data t′ according to the following expressions, and calculates the transformed target data (hereinafter, referred to as “transformed target data”) t″.

$$[ Formula 12 ]$$

$${t}_{j}^{″} := ( {\sum }_{j ∈ \{ 1 , … , k \}} {t}_{j}^{′} ) \cdot \frac{g ( j )}{{\sum }_{1}^{k} g ( j )} ( j = 1 , … , k ) \qquad ( 11 )$$

$${t}_{j}^{″} := {t}_{j}^{′} ( j = k + 1 , … , N ) \\ g ( j ) = {y}_{j}^{′} \qquad ( 12 )$$

Here, an expression (11) shows the transformed target data t″ⱼ for the topk class, and an expression (12) shows the transformed target data t″ⱼ for classes other than the topk class. For instance, in a case where a correct answer class (a class which value is “1”) in the target data t′ is included in the topk class, the value t″ⱼ for each class belonging to the topk class is a value obtained by allocating the value “1” with the predicted probability corresponding to the class. In this case, all the values of the transformed target data t″ⱼ of classes other than the topk class are set to “0”. On the other hand, in a case where the correct answer class in the target data t′ is included in a class other than the topk class, all the values t″ⱼ of classes belonging to the topk class become “0”, and values of the transformed target data t″ⱼ for the classes other than the topk class become the same as those of the target data t′ⱼ prior to the transformation. That is, the same class as the target data t′ⱼ before the transformation becomes the correct answer class (a value is “1”). Target transformation unit 62 outputs the calculated transformed target data t″ⱼ to the loss calculation unit 40.

The loss calculation unit 40 calculates the loss Lₜₒₚₖ by using the following expression using the transformed target data t″ⱼ and the predictive classification information y′_{b}.

[Formula 13]

Lₜₒₚₖ=Σ_{i∈J}t″ⱼ log y′_{b,j}

J={topk,k+1, . . . ,N} (13)

Alternatively, the loss calculation unit 40 may calculate the loss Lₜₒₚₖ by using the following expression using the transformed target data t″ⱼ and the predicted classification information.

$$[ Formula 14 ]$$

$${L}_{topk} = {\sum }_{j ∈ J} {t}_{j}^{″} log ( \frac{{t}_{j}^{″}}{{y}_{b , j}^{′}} ) \qquad ( {13}^{′} )$$

As in the first example, the model update unit 50 updates the parameters of the model set in the model update unit 50 based on the loss Lₜₒₚₖ to generate the updated model f(w_{b}), and sets the updated model f(w_{b}) in the model update unit 50 and the prediction unit 20.

(2) Learning Process

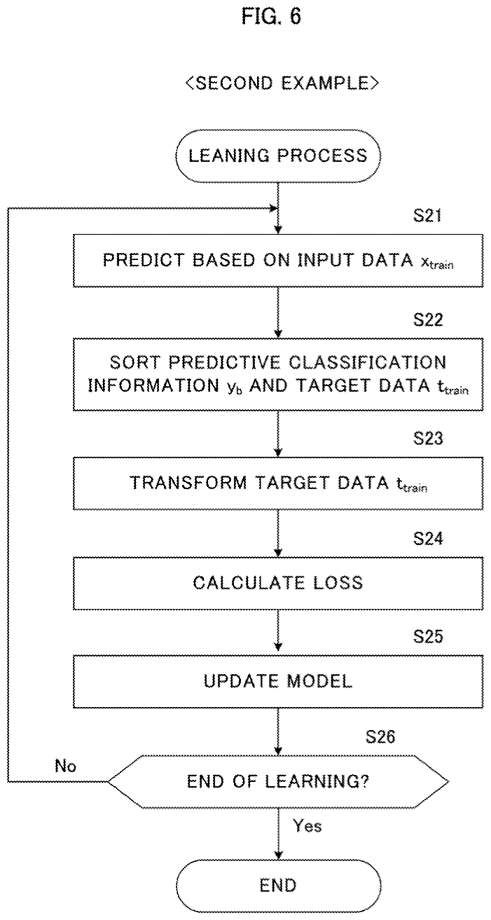

FIG. 6 is a flowchart of a learning process according to a second example. This learning process is realized by the processor 13, which is depicted in FIG. 1, executes a program prepared in advance, and operates as each element depicted in FIG. 5. At a start of the learning process, an initial model f(wᵢₙᵢₜ) is set in the prediction unit 20 and the model update unit 50.

First, the prediction unit 20 predicts a class based on input data xₜᵣₐᵢₙ, and outputs predictive classification information y_{b} shown in the expression (1) as a prediction result (step S21). Next, the sorting unit 61 of the grouping unit 60 predictive classification information y_{b} and target data tₜᵣₐᵢₙ (step S22) as shown in the expressions (3) and (4).

Next, the target transformation unit 62 of the grouping unit 60 transforms the target data t′ in accordance with the expressions (11) and (12) by using the predicted classification information y′_{b}, and calculates the transformed target data t″ⱼ (step S23).

Next, the loss calculation unit 40 calculates a loss Lₜₒₚₖ based on the expression (13) or the expression (13′) using the transformed target data t″ⱼ and the predicted classification information y′_{b}. Next, the model update unit 50 updates parameters of the model so as to reduce the loss Lₜₒₚₖ, and sets the updated model f(w_{b}) to the prediction unit 20 and the model update unit 50 (step S25).

Next, the model update unit 50 determines whether or not a predetermined end condition is provided (step S26). When the end condition is not provided (step S26: No), processes of steps S21 through S25 are performed using next input data xₜᵣₐᵢₙ and next target data tₜᵣₐᵢₙ. On the other hand, when the end condition is provided (step S26: Yes), the learning process is terminated.

As described above, in the second example, by transforming only the target data, it is possible to generate a model for detecting with high accuracy that there is a correct answer in top k classes of high predicted probabilities.

(3) Grouping Methods

Also in the second example, similarly to the first example embodiment, a plurality of classes can be grouped by methods (A) to (D).

(4) Objective Data for Grouping Classes

(A) Grouping Top k Classes

The transformed target data t″ⱼ are given by the expressions (11) and (12) above.

(B) Grouping Classes of a (k+1)th or Lower Ranks

The transformed target data t″ⱼ are given by the following expressions.

$$[ Formula 15 ]$$

$${t}_{j}^{″} := {t}_{j}^{′} ( j = 1 , … , k ) \qquad ( 14 )$$

$${t}_{j}^{″} := ( {\sum }_{j ∈ \{ k + 1 , … , N \}} {t}_{j}^{′} ) \cdot \frac{- g ( N - j + 1 )}{{\sum }_{k + 1}^{N} g ( N - j + 1 )} ( j = k + 1 , … , N ) \qquad ( 15 )$$

Here, the expression (14) shows the transformed target data t″ⱼ for the top k classes, and the expression (15) shows the transformed target data t″ⱼ for classes other than the top k classes. Since the expression (15) takes a value other than “0” in a case where the top k classes do not include a correct answer, a sign of the function g(j) is set to minus (−), so that a value of a loss increases in the case where the top k classes do not include a correct solution.

(C) Grouping Both Top k Classes and (k+1)th or Lower Classes

The transformed target data t″ⱼ are given by the following expressions.

$$[ Formula 16 ]$$

$${t}_{j}^{″} := 2 ( {\sum }_{j ∈ \{ 1 , … , k \}} {t}_{j}^{′} ) \cdot \frac{g ( j )}{{\sum }_{1}^{k} g ( j )} ( j = 1 , … , k ) \qquad ( 16 )$$

$${t}_{j}^{″} := ( {\sum }_{j ∈ \{ k + 1 , … , N \}} {t}_{j}^{′} ) \cdot \frac{- g ( N - j + 1 )}{{\sum }_{k + 1}^{N} g ( N - j + 1 )} ( j = k + 1 , … , N ) \qquad ( 17 )$$

Here, the expression (16) shows the transformed target data t″ⱼ for the top k classes, and the expression (17) shows the transformed target data t″ⱼ for classes other than the top k classes. In the expression (16), when a correct answer class in the target data t′ is included in the top k classes, the value t″ⱼ of the top k classes is obtained by doubling a value, which is allocated to each class with the predicted probability for each class with respect to the value “1” representing the correct answer class. The expression (17) is the same as in the expression (15) described above.

(D) Grouping Both a First Class and the Top k Classes

The transformed target data t″ⱼ are given by the following expressions.

$$[ Formula 17 ]$$

$${t}_{j}^{″} := {w}_{1} \cdot ( {\sum }_{j ∈ \{ 1 , … , k \}} {t}_{j}^{′} ) \cdot \frac{g ( j )}{{\sum }_{1}^{k} g ( j )} ( j = 1 ) \qquad ( 18 )$$

$${t}_{j}^{″} := ( 1 - {w}_{1} ) \cdot ( {\sum }_{j ∈ \{ 1 , … , k \}} {t}_{j}^{′} ) \cdot \frac{g ( j )}{{\sum }_{1}^{k} g ( j )} ( j = 1 , … , k ) \\ {t}_{j}^{″} := {t}_{j}^{′} ( j = k + 1 , … , N ) \qquad ( 19 )$$

Here, the expression (18) shows the transformed target data t″ⱼ for the first class, and the expression (19) shows the transformed target data t″ⱼ for a second to kth classes. The “w₁” denotes a weight representing a ratio that emphasizes the first class among the first class and the top k classes, and is set to a value from “0” to “1”.

Note that, in each of the above expressions, the function g(j) can use any of the following equations.

[Formula 18]

g(j)=1, g(j)=e^{-j}, g(j)=1/j, g(j)=y′ⱼ, g(j)=y′ⱼ²

### Third Example

Next, a third example of the present disclosure will be described. In the first example, for the topk class, the predictive classification information y′_{b} and the target data t′ are transformed to determine the loss. In the third example, instead, for the top k class, k, which is the number of classes to be grouped, is changed to generate a plurality of pairs of predictive classification information y_{b}′ₖ and target data t′ₖ, and a single loss is obtained as a mixing loss using the generated plurality of pairs of grouped classification information (y_{b}′, t′).

(1) Functional Configuration

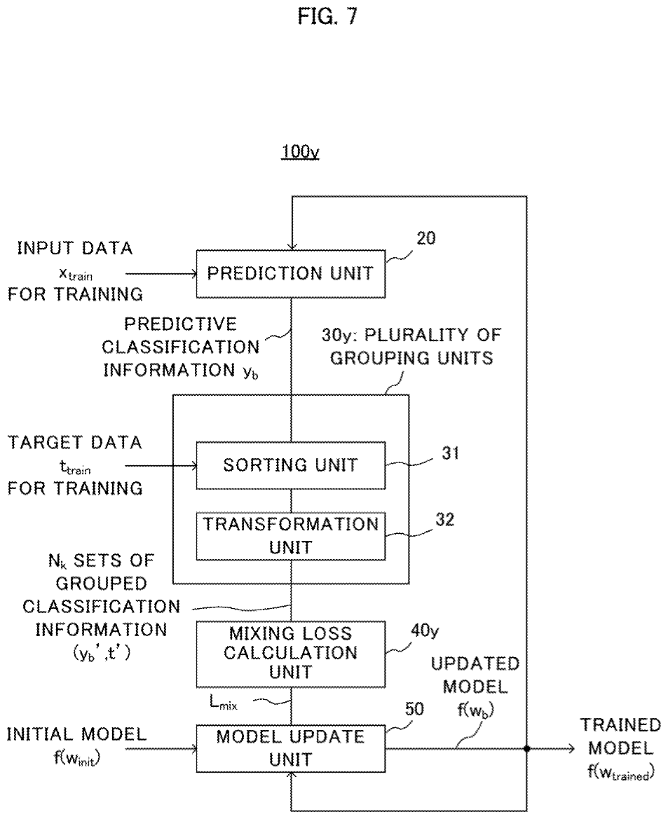

FIG. 7 is a block diagram illustrating a functional configuration of a learning apparatus 100y according to the third example. As illustrated, the learning apparatus 100y includes a plurality of grouping units 30y, instead of the grouping units 30 in the learning apparatus 100 according to the first example, and includes a mixing loss calculation unit 40y instead of the loss calculation unit 40. The prediction unit 20 and the model update unit 50 are the same as those in the first example.

The plurality of the grouping units 30y performs the same operation as the grouping unit 30 of the first example multiple times by changing k representing the number of classes to be grouped to be k₁, k₂, . . . , k_{Nk} and k, and generates grouped predictive classification information y_{b}′ₖ and grouped target data t′ₖ for each k. As a result, the plurality of the grouping unit 30y generates Nₖ sets of grouped classification information (y_{b}′, t′).

The mixing loss calculation unit 40y calculates a mixing loss Lₘᵢₓ using a plurality of pairs of the grouped predictive classification information y_{b}′ₖ and the grouped target data t′ₖ, which are generated by the plurality of grouping units 30y. For instance, when k is a value kᵢ, the mixing loss calculation unit 40y calculates the mixing loss Lₘᵢₓ by the following expression, which uses a loss function L(tₖᵢ′, y_{b}′ₖᵢ) representing a degree of a difference between the grouped target data t′ₖ and the grouped predictive classification information y_{b}′ₖ, and a specific function αₖᵢ(y_{b} t, b) depending on the prediction result y_{b} and the target data t, a learning count b, and the like.

[Formula 19]

Lₘᵢₓ=Σᵢ₌₁^{N}^{ₖ}αₖ_{ᵢ}(y_{b},t,b)·L(tₖ_{ᵢ}′,y_{b}′ₖ_{ᵢ}) (20)

This expression (20) calculates a mixing loss by combining a loss for each k calculated using the grouped predictive classification information y_{b}′ₖ and the grouped target data t′ₖ.

Incidentally, for instance, the loss function L(tₖ_{ᵢ}′, y_{b}′ₖᵢ) may be calculated by the expressions (9) or (10), similar to the loss which the loss calculation unit 40 of the first example calculates. Also, the specific function αₖ may be a default value.

Moreover, the mixing loss calculation unit 40y may calculate the mixing loss Lₘᵢₓ by the following expression using the above-described loss function and specific function.

$$\begin{matrix}[ Formula 20 ] & \\ {L}_{m i x} = max [ {α}_{1} ( {y}_{b} , t , b ) \cdot L ( {t}_{{k}_{1}}^{′} , {y}_{{b}^{′} {k}_{1}} ) , … , {α}_{{N}_{k}} ( {y}_{b} , t , b ) \cdot L ( {t}_{{k}_{{N}_{k}}}^{′} , {y}_{{b}^{′} {k}_{{N}_{k}}} ) ] & ( 21 )\end{matrix}$$

The expression (21) compares the loss for each k calculated using the grouped predictive classification information y_{b}′k and the grouped target data t′ₖ, and the greatest value is regarded as the mixing loss. Note that the specific function αₖ may be a default value.

Moreover, the mixing loss calculation unit 40y may calculate the mixing loss Lₘᵢₓ by the following formula using the above-described loss function and predetermined values aₖ, bₖ, cₖ, and dₖ.

[Formula 21]

Lₘᵢₓ=Σᵢ₌₁^{N}^{ₖ}L(aₖ_{ᵢ}t′ₖ_{ᵢ}+bₖ_{ᵢ},cₖ_{ᵢ}y_{b}′ₖ_{ᵢ}+dₖ_{ᵢ}) (22)

This expression (22) calculates the mixing loss using a value obtained by transforming the grouped target data t′ₖ using predetermined values aₖ and bₖ, and a value obtained by transforming the grouped predictive classification information y_{b}′ₖ using predetermined values cₖ and dₖ.

Moreover, for instance, using the above expression (22), when k={1, m},

$$[ Formula 22 ]$$

$$( {a}_{1} , {b}_{1} , {c}_{1} , {d}_{1} ) = ( 1 , 0 , \frac{m}{m + 1} , \frac{1}{m + 1} ) , \\ ( {a}_{m} , {b}_{m} , {c}_{m} , {d}_{m} ) = ( 1 , 0 , 1 , 0 )$$

As a result, the mixing loss Lₘᵢₓ may be calculated.

(2) Learning Process

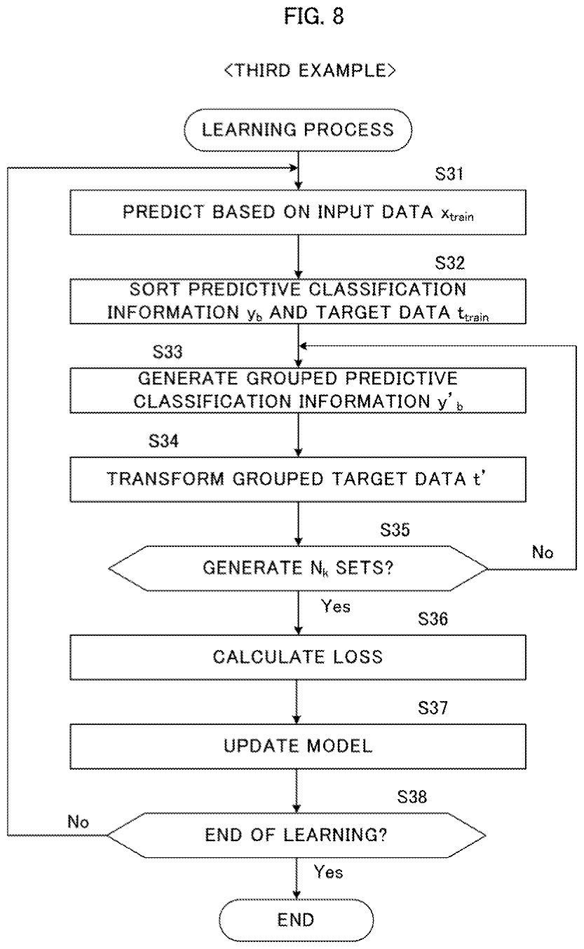

FIG. 8 is a flowchart of a learning process according to the third example. This learning process is realized by the processor 13, which is depicted in FIG. 1, executes a program prepared in advance, and operates as each element depicted in FIG. 7. At a start of the learning process, the initial model f(wᵢₙᵢₜ) is set in the prediction unit 20 and the model update unit 50.

First, the prediction unit 20 predicts a class for the input data xₜᵣₐᵢₙ and outputs the predictive classification information y_{b} shown in the expression (1) as a prediction result (step S31). Next, the sorting unit 31 of the plurality of grouping unit 30y sorts predictive classification information y_{b} and the target data tₜᵣₐᵢₙ for training, as shown in the expressions (3) and (4) (step S32).

Next, the transformation unit 32 of the plurality of grouping units 30y calculates, regarding k classes, predicted probability y′ₜₒₚₖ for the topk class shown in the expression (5) from the top k predicted probabilities of the sorted predicted classification information y′_{b}, and generates grouped predicted classification information y′_{b, topk} by replacing the predicted probabilities of the k classes forming the topk class with the predicted probability y′ₜₒₚₖ of the topk class as shown in the expression (6) (step S33). Moreover, the transformation unit 32 calculates a value t′ₜₒₚₖ of the target data for the topk class shown in the expression (7), and generates the grouping target data t′ by replacing values of the target data for the k classes forming the topk class in the target data t′ with the value t′ₜₒₚₖ of the target data of the topk class as shown in the expression (8) (step S34).

Next, the plurality of grouping unit 30y determines whether or not Nₖ sets of the grouped classification information (y′_{b}, t′) have been generated (step S35). When the plurality of grouping units 30y have not created the Nₖ sets of the grouped classification information (y′_{b}, t′) (step S35: No), the learning process returns to step S32, and the plurality of grouping units 30y generate grouped classification information (y′_{b}, t′) with respect to a next number k in classes.

On the other hand, when the plurality of grouping units 30y generate the Nₖ sets of the grouped classification information (y′_{b}, t′) (step S35: Yes), the mixing loss calculation unit 40y calculates the loss Lₘᵢₓ using any of the above-described expressions 20 to 22 (step S36). Next, the model update unit 50 updates parameters of a model so as to reduce the loss Lₘᵢₓ, and sets the updated model f(w_{b}) to the prediction unit 20 and the model update unit 50 (step S37).

Next, the model update unit 50 determines whether or not a predetermined end condition is provided (step S38). When the end condition is not provided (step S38: No), processes from steps S31 through S37 are performed using next input data xₜᵣₐᵢₙ and target data tₜᵣₐᵢₙ. On the other hand, when the end condition is provided (step S38: Yes), the learning process is terminated.

As described above, in the third example, since the mixing loss is obtained by using the plurality of sets of the grouped classification information and the model is trained, the model can be trained so as to balance accuracies of the plurality of sets of the topk classes. For instance, when two sets of grouped classification information with k=1 and 3 are used to obtain the mixing loss and the learning is performed, it is possible to generate a model that can balance an accuracy of the top1 class and an accuracy of the top3 class.

(Information Integration System)

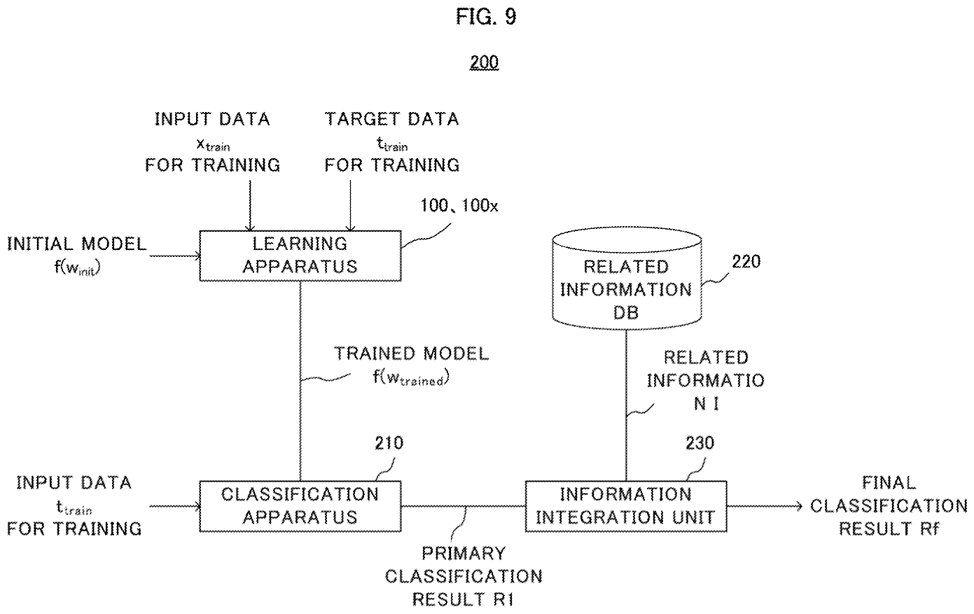

Next, an information integration system will be described according to the first example embodiment. FIG. 9 is a block diagram illustrating a configuration of an information integration system 200. As illustrated, the information integration system 200 includes the learning system 100 according to the first example or the learning system 100x according to the second example, a classification apparatus 210, a related information DB 220, and an information integration unit 230.

As described above, the learning apparatus 100 or 100x trains the initial model f(wᵢₙᵢₜ) using the input data xₜᵣₐᵢₙ and the target data tₜᵣₐᵢₙ, and generates a trained model f(w_{trained}). The classification apparatus 210 is an apparatus that performs a class classification using the trained model f(w_{trained}), and practical input data x are input. The practical input data x are the image data to be actually classified. The classification apparatus 210 classifies the practical input data x using the trained model f(w_{trained}), generates a primary classification result R1, and outputs the primary classification result R1 to the information integration unit 230. The primary classification result R1 is generated by the learning apparatus 100 according to the first example or the learning apparatus 100x according to the second example, and includes the above-described predicted probability of the top k class, that is, the probability that a target object is one of classes forming the top k class. In other words, the classification apparatus 210 outputs the primary classification result R1 reducing a large number of target objects to k target objects.

The related information DB stores related information I. The related information I is additional information used in classifying the practical input data x, and is information obtained by a route or method different from that of the practical input data x. For instance, in a case where the practical input data are a captured image by a camera, it is possible to use a sensor image obtained using a radar or a sensor as the related information I.

The information integration unit 230 acquires the related information I corresponding to the practical input data x from the related information DB 220 when the primary classification result R1 is acquired from the classification apparatus 210. After that, the information integration unit 230 ultimately determines one class from k classes indicated by the first classification result R1, by using the acquired related information I, and outputs the determined class as a final classification result Rf. That is, the information integration unit 230 further reduces the k classes reduced by the classification apparatus 210 to one class. The information integrating unit 230 may generate the final classification result Rf using a plurality sets of the related information I concerning the practical input data x. In the above configuration, the classification apparatus 210 is an example of a primary classification apparatus in the present disclosure, and the information integration unit 230 is an example of a secondary classification apparatus in the present disclosure.

In the information integration system described above, since the related information I corresponding to the practical input data x is prepared, it is not necessary for the classification apparatus 210 to reduce the classification result of the practical input data x to one class. That is, the classification apparatus 210 can detect that the practical input data x are included in the top k class with a high probability. As described above, it is possible for the learning apparatuses 100 and 100x according to the first example embodiment to be preferably applied to a system that can use additional information such as the above-described information integration system.

### Second Example Embodiment

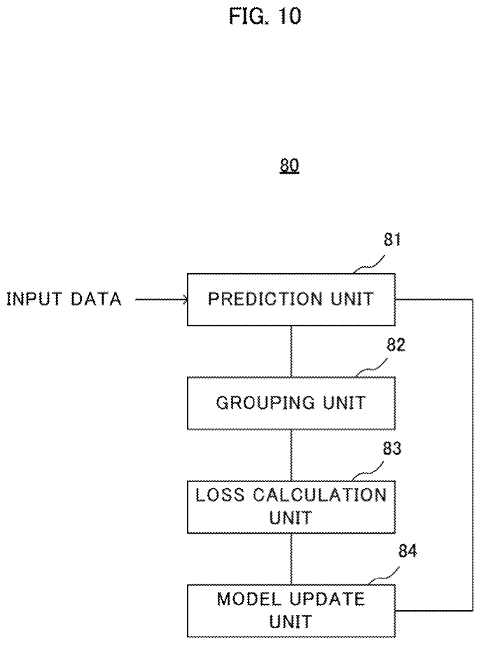

Next, a second example embodiment of the present disclosure will be described. FIG. 10 is a block diagram illustrating a functional configuration of a learning apparatus according to the second example embodiment. A hardware configuration of a learning apparatus 80 is the same as that depicted in FIG. 1. As illustrated, the learning apparatus 80 includes a prediction unit 81, a grouping unit 82, a loss calculation unit 83, and a model update unit 84.

The prediction unit 81 classifies input data into one of a plurality of classes using a prediction model, and outputs a predicted probability for each class as a prediction result. The grouping unit 82 generates a grouped class formed by k classes in which a predicted probability likely for a correct answer is included in predicted probabilities of the top k classes, based on the predicted probabilities corresponding to respective classes, and calculates the predicted probability of the grouped class. The loss calculation unit 83 calculates a loss based on the predicted probabilities of a plurality of classes including the grouped class. The model update unit 84 updates a predictive model based on the calculated loss. Therefore, it is possible for the learning apparatus 80 to generate a model that outputs respective predicted probabilities of the top k classes in predicted probability with high accuracy.

A part or all of the example embodiments described above may also be described as the following supplementary notes, but not limited thereto.

(Supplementary Note 1)

1. A learning apparatus comprising:

a prediction unit configured to classify input data into a plurality of classes by using a predictive model, and output a predicted probability for each class;

a grouping unit configured to generate a grouped class formed by k classes within top k predicted probabilities based on the predicted probability for each class, and calculate a predicted probability of the grouped class;

a loss calculation unit configured to calculate a loss based on predicted probabilities of the plurality of classes including the grouped class; and

a model update unit configured to update the predictive model based on the calculated loss.

(Supplementary Note 2)

2. The learning apparatus according to claim 1, wherein the predicted probability of the grouped class is a probability that a correct answer is included in the k classes forming the grouped class.

(Supplementary Note 3)

3. The learning apparatus according to claim 1 or 2, wherein the grouping unit sorts predicted probabilities corresponding to respective classes, which are output by the prediction unit, and determines the k classes.

(Supplementary Note 4)

4. The learning apparatus according to any one of claims 1 through 3, wherein

the grouping unit further includes a transformation unit configured to generate a transformed prediction result in which the predicted probabilities of the k classes forming the grouped class are replaced with the predicted probability of the grouped class, and transformed target data in which values of target data for the k classes forming the grouped class are replaced with a value of the target data for the grouped class, and

the loss calculation unit calculates the loss based on the transformed prediction result and the transformed target data.

(Supplementary Note 5)

5. The learning apparatus according to claim 4, wherein the transformation unit sets a sum of the predicted probabilities of the k classes forming the grouped class to the predicted probability of the grouped class, and sets a sum of values of the target data included in the k classes forming the grouped class to a value of the target data of the grouped class.

(Supplementary Note 6)

6. The learning apparatus according to any one of claims 1 through 3, wherein

the grouping unit includes a transformation unit configured to generate transformed target data by transforming the target data by using predicted probabilities of the k classes forming the grouped class, and

the loss calculation unit calculates the loss based on the prediction result output from the prediction unit and the transformed target data.

(Supplementary Note 7)

7. The learning apparatus according to claim 6, where the transformation unit sets values obtained by allocating a sum of the values of the target data for the k classes forming the grouped class with the prediction probabilities of the k classes, to values of the target data respectively for the k classes.

(Supplementary Note 8)

8. The learning apparatus according to any one of claims 1 through 7, wherein the grouping unit determines a value of k based on the predicted probability of each class output from the prediction unit and a specific value.

(Supplementary Note 9)

9. The learning apparatus according to claim 4 or 5, wherein

the transformation unit generates a plurality of pairs of transformed prediction results and transformed target data using a value of k, and

the loss calculation unit calculates a single loss based on the plurality of pairs of transformed prediction results and transformed target data.

(Supplementary Note 10)

10. The learning apparatus according to claim 9, wherein the loss calculation unit sets, as the loss, a value obtained by synthesizing the transformed prediction result and the transformed target data for each number of classes to be grouped.

(Supplementary Note 11)

11. The learning apparatus according to claim 9, wherein the loss calculation unit compares losses calculated by using the transformed prediction result and the transformed target data for each number of classes to be grouped, and determines a greatest value as the loss.

(Supplementary Note 12)

12. The learning apparatus according to claim 10 or 11, wherein the loss calculation unit uses a value in which the transformed prediction result is transformed, instead of the transformed prediction result, in a case of calculating the loss for each number of classes to be grouped, and uses a value in which the transformed target data are transformed, instead of the transformed target data.

(Supplementary Note 13)

13. An information integration system, comprising:

the learning apparatus according to any one of claims 1 through 12;

a primary classification apparatus configured to classify practical input data into a plurality of classes including the grouped class by using a predictive model trained by the learning apparatus; and

a secondary classification apparatus configured to classify the practical input data into one of k classes forming the grouped class by using additional information.

(Supplementary Note 14)

14. A learning method comprising:

classifying input data into a plurality of classes using a predictive model and outputting a predictive probability for each class as a prediction result;

generating a grouped class formed by k classes within top k predicted probabilities based on the predicted probability for each class, and calculating a predicted probability of the grouped class;

calculating a loss based on predicted probabilities of the plurality of classes including the grouped class; and

updating the predictive model based on the calculated loss.

(Supplementary Note 15)

15. A recording medium storing a program, the program causing a computer to perform a process comprising:

classifying input data into a plurality of classes using a predictive model and outputting a predictive probability for each class as a prediction result;

generating a grouped class formed by k classes within top k predicted probabilities based on the predicted probability for each class, and calculating a predicted probability of the grouped class;

calculating a loss based on predicted probabilities of the plurality of classes including the grouped class; and

updating the predictive model based on the calculated loss.

This application claims priority on the basis of International Application No. PCT/JP2019/043909 filed on Nov. 8, 2019 and incorporates all of its disclosures herein.

While the disclosure has been described with reference to the example embodiments and examples, the disclosure is not limited to the above example embodiments and examples. Various changes which can be understood by those skilled in the art within the scope of the present disclosure can be made in the configuration and details of the present disclosure.

### DESCRIPTION OF SYMBOLS

10, 100, 100x Learning apparatus
20 Prediction unit
30, 60 Grouping unit
31, 61 Sorting unit
32 Transformation unit
40 Loss calculation unit
50 Model update unit
62 Target transformation unit
200 Information integration system
210 Classification apparatus
220 Related information DB
230 Information integration unit

What is claimed is:

1. A learning apparatus comprising:
a memory storing instructions; and
one or more processors configured to execute the instructions to:
classify input data into a plurality of classes by using a predictive model, and output a predicted probability for each class;
generate a grouped class formed by k classes within top k predicted probabilities based on the predicted probability for each class, and calculate a predicted probability of the grouped class;
calculate a loss based on predicted probabilities of the plurality of classes including the grouped class; and
update the predictive model based on the calculated loss.

2. The learning apparatus according to claim 1, wherein the predicted probability of the grouped class is a probability that a correct answer is included in the k classes forming the grouped class.

3. The learning apparatus according to claim 1, wherein the processor sorts predicted probabilities corresponding to respective classes, which are output when classifying the input data, and determines the k classes.

4. The learning apparatus according to claim 1, wherein
the processor generates a transformed prediction result in which the predicted probabilities of the k classes forming the grouped class are replaced with the predicted probability of the grouped class, and transformed target data in which values of target data for the k classes forming the grouped class are replaced with a value of the target data for the grouped class, when generating the grouped class, and
the processor calculates the loss based on the transformed prediction result and the transformed target data.

5. The learning apparatus according to claim 4, wherein the processor sets a sum of the predicted probabilities of the k classes forming the grouped class to the predicted probability of the grouped class, and sets a sum of values of the target data included in the k classes forming the grouped class to a value of the target data of the grouped class.

6. The learning apparatus according to claim 1, wherein
the processor generates transformed target data by transforming the target data by using predicted probabilities of the k classes forming the grouped class, when generating the grouped class, and
the processor calculates the loss based on the prediction result output when classifying the input data and the transformed target data.

7. The learning apparatus according to claim 6, where the processor sets values obtained by allocating a sum of the values of the target data for the k classes forming the grouped class with the prediction probabilities of the k classes, to values of the target data respectively for the k classes.

8. The learning apparatus according to claim 1, wherein the processor determines a value of k based on the output predicted probability of each class and a specific value.

9. The learning apparatus according to claim 4, wherein
the processor generates a plurality of pairs of transformed prediction results and transformed target data using a value of k, and
the processor calculates a single loss based on the plurality of pairs of transformed prediction results and transformed target data.

10. The learning apparatus according to claim 9, wherein the processor sets, as the loss, a value obtained by synthesizing the transformed prediction result and the transformed target data for each number of classes to be grouped.

11. The learning apparatus according to claim 9, wherein the processor compares losses calculated by using the transformed prediction result and the transformed target data for each number of classes to be grouped, and determines a greatest value as the loss.

12. The learning apparatus according to claim 10, wherein the processor uses a value in which the transformed prediction result is transformed, instead of the transformed prediction result, in a case of calculating the loss for each number of classes to be grouped, and uses a value in which the transformed target data are transformed, instead of the transformed target data.

13. An information integration system, comprising:
a learning apparatus according to claim 1;
a primary classification apparatus configured to classify practical input data into a plurality of classes including the grouped class by using a predictive model trained by the learning apparatus; and
a secondary classification apparatus configured to classify the practical input data into one of k classes forming the grouped class by using additional information.

14. A learning method comprising:
classifying input data into a plurality of classes using a predictive model and outputting a predictive probability for each class as a prediction result;
generating a grouped class formed by k classes within top k predicted probabilities based on the predicted probability for each class, and calculating a predicted probability of the grouped class;
calculating a loss based on predicted probabilities of the plurality of classes including the grouped class; and
updating the predictive model based on the calculated loss.

15. A non-transitory computer-readable recording medium storing a program, the program causing a computer to perform a process comprising:
classifying input data into a plurality of classes using a predictive model and outputting a predictive probability for each class as a prediction result;
generating a grouped class formed by k classes within top k predicted probabilities based on the predicted probability for each class, and calculating a predicted probability of the grouped class;
calculating a loss based on predicted probabilities of the plurality of classes including the grouped class; and
updating the predictive model based on the calculated loss.
